(19) United States
(12) Patent Application Publication
(10) Pub. No.: US 2010/0162948 A1
(43) Pub. Date: Jul. 1, 2010

(54) COOKING WIPES AND DISPENSERS FOR SAME

(76) Inventor: Donna J. Azarian, Eden Prairie, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 12/663,022

(22) PCT Filed: Jun. 18, 2008
(86) PCT No.: PCT/US08/67378

§ 371 Date: Dec. 4, 2009

Related U.S. Application Data
(60) Provisional application No. 60/944,812, filed on Jun. 19, 2007.

(51) Int. Cl. A47J 43/28

(52) U.S. Cl. 118/13

(57) ABSTRACT

A cooking oil wipe for coating a cooking surface with cooking oil. The cooking oil wipe includes a sheet permeated with an amount of cooking oil to uniformly coat at least a typical household cooking surface. The cooking oil wipes are removable from sealed dispensers. In use, a cooking oil wipe is removed from the dispenser and wiped over the cooking surface to uniformly cover the cooking surface with cooking oil.

### BACKGROUND

When preparing a frying pan, baking pan, griddle or the like for cooking, the cooking surface is typically coated with vegetable oil, butter, shortening or other fat to prevent the food from sticking to the pan and often for flavoring. Typical methods for coating frying pans or griddles usually includes spraying the cooking surface with cooking oil spray, pouring oil into the pan, or putting a dollop of butter, shortening or fat directly onto the cooking surface and spreading it with a cooking utensil or tipping and rotating the pan until it melts and coats the cooking surface. For baking pans, the pan is typically coated using a cooking spray or by smearing the pan with a butter or shortening using a paper towel or waxed paper.

With any of the above-described cooking surface coating methods, it is difficult to obtain a uniform coating across the cooking surface. Additionally, it is difficult to control the amount of oils or fats being applied to minimize unwanted calories while still ensuring sufficient coating of the cooking surface to prevent food sticking. Furthermore, when coating a baking pan using butter or shortening the cook has to first remove a paper towel or sheet of waxed paper, wrap it around his or her hand, dip it into the butter or shortening, wipe the pan, and then discard the sheet in the waste basket. This method is inefficient, inconvenient and messy for the cook. It is also wasteful not only of paper towels or waxed paper, but also of the butter or shortening because the cook will inevitably get more butter or shortening on the sheet than is necessary to coat the pan. Accordingly, there is a need for an improved system and method of coating cooking surfaces in preparation for cooking.

### BRIEF DESCRIPTION OF THE DRAWINGS

FIG. 1 illustrates a preferred embodiment of a cooking oil wipe in accordance with the present invention.

FIG. 2 illustrates one embodiment of a dispenser for the cooking oil wipes of FIG. 1.

FIG. 3 illustrates another embodiment of a dispenser for the cooking oil wipes of FIG. 1.

### DETAILED DESCRIPTION

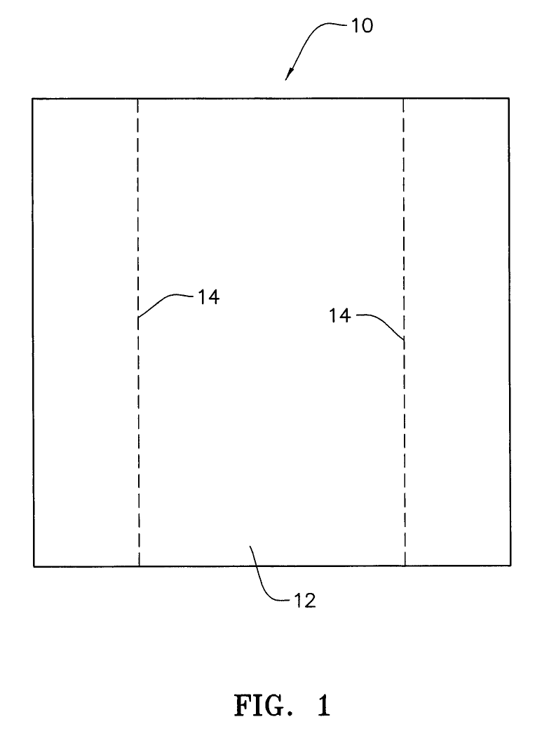

Referring now to the drawings, wherein like reference numerals designate identical or corresponding parts throughout the several views, FIG. 1 illustrates a preferred embodiment of a cooking oil wipe 10 of the present invention for coating a cooking surface, such as a frying pan, baking pan, griddle, or the like.

The cooking oil wipe 10 comprises a pliable sheet 12 preferably made of biodegradable natural fibers suitable for use in food preparation. However, the sheet 12 may be made from any material, natural or synthetic, suitable for food preparation. Whatever the material, it is preferred that the sheet 12 does not lose fibers or does not easily tear so as to avoid fibers or pieces of the sheet 12 remaining on the cooking surface after use. The sheet 12 is preferably porous such that it is permeable to cooking oils. The cloth is also preferably somewhat absorbent so as to be able to sufficiently retain enough oil within the sheet 12 to ensure adequate uniform coating of at least the typical household cooking surface when the wipe 10 is wiped across the cooking surface. The sheet 12 may be any desired size or shape, and may have any desired texture appropriate for the cooking surface on which the wipe 10 is to be used. Further, the sheet 12 may include fold lines 14 to allow larger sized sheets to be stacked in dispensers 16 and to assist in the selection and removal of individual sheets 12 from the dispenser 16 (discussed later).

The cooking oil used with the wipe 10 may include olive oil, canola oil, peanut oil, coconut oil and other oils used for cooking. Additionally, the oil may be flavored or unflavored.

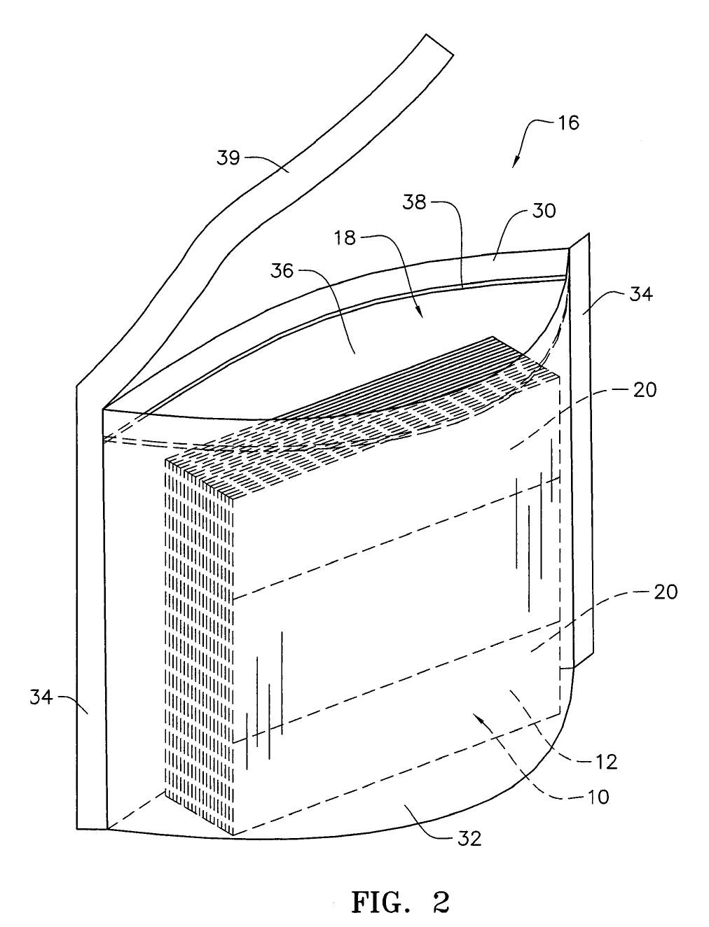

FIG. 2 illustrates one embodiment of a dispenser 16 in which a plurality of wipes 10 are disposed in stacked relation and from which individual wipes 10 are individually selectively removable through an opening 18 in the dispenser 16. As is conventional, the individual sheets 12 are preferably folded to permit the user to grasp the fold 20 to remove one sheet at a time through the opening 18 in the dispenser 16. In general, the dispenser 16 is preferably made of a material impermeable to cooking oil, such as plastic, foil or the like. The opening 18 is preferably re-sealable to avoid premature drying out of the wipes 10, to preserve the freshness of the oil and to avoid contamination of the wipes 10. The dispenser 16 may be made of transparent, translucent or opaque material as desired.

In the embodiment of FIG. 2, the dispenser 16 is in the form of an envelope or bag 30 that may be formed from a single panel 32 that is folded and sealed along its adjacently disposed peripheral edges 34, thereby defining an interior volume 36 within which the wipes 10 are stored until being selectively removed through the opening 18. Alternatively, it should be understood that the envelope 30 may comprise two or more panels sealed along their adjacently disposed peripheral edges to define an interior volume. In the preferred embodiment, the means for re-sealing the opening 18 of the envelope 30 is be a “zipper” type seal 38 that is pressed together or which utilizes a slider to “zip” and “un-zip” the interlocking ribs of the seal, for example as used on conventional storage bags such as the Ziploc® storage bags, Glad® Snap Lock®, or the Glad Zip-Slide® storage bags. Other means of sealing as recognized by those of skill in the art may be equally suitable for sealing and therefore the envelope embodiment of the dispenser should not be construed as being limited to a zipper-type seal. Additionally, the envelope 30 may include a tear away top section 39 to provide a tamper-evident seal as is commonly used on various packages for food items that utilize similar zipper-type seals.

It should also be appreciated that the envelope 30 may include a single cooking wipe 10 instead of a plurality of wipes 10. For such singles, there would be no need to provide a means for resealing the opening 18 of the envelope 30, since the single wipe 10 would be discarded after use. Thus, for singles, the envelope 30 may simply comprise a sealed plastic or foil envelope with a slit or perforation along one side to facilitate the opening of the envelope 30 for access to and removal of the single cooking wipe 10 through the opening 18.

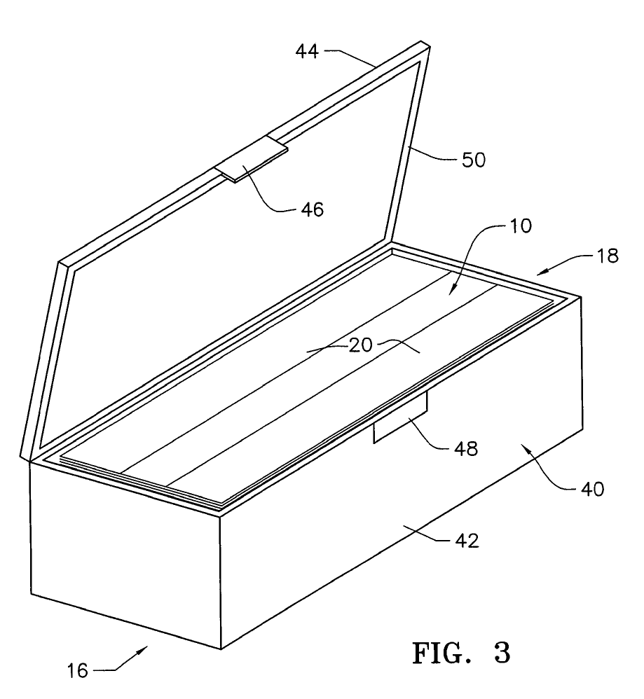

FIG. 3 illustrates another embodiment of a dispenser 16 for the cooking wipes 10 of the present invention. In this embodiment, the dispenser 16 comprises a box 40 having a bottom portion 42 and a top lid portion 44. The bottom and top portions 42, 44 are preferably hingedly connected along one side to permit the lid 44 to be hingedly movable between an open position and a closed position. Mating tabs 46, 48 are preferably provided at a mating edge of the lid 44 and bottom 42 to secure the lid 44 in the closed position. A gasket 50 may be provided around the periphery of the lid 44 to provide a substantially air-tight seal with the bottom 42 when in the closed position. A plurality of oil permeated wipes 10 are removably stored within the bottom portion 42 in stacked relation. To remove a wipe 10 from the box 40, the mating tabs 46, 48 are disengaged and the lid 44 is hingedly moved from the closed position to the open position. A wipe 10 is selectively removed through the opening 18, after which the lid 44 is closed over the opening 18 and the mating tabs engage to secure the lid in the closed position.

It should be appreciated that in any of the above-described embodiments, rather than the wipes 10 comprising a plurality of individual stacked sheets 12, the wipes 10 may be arranged in a roll. In such an embodiment, the wipes 10 may include a tear line by perforating the roll of wipes at predefined distances thereby permitting individual sheets 12 to be torn from the remainder of the roll along the tear lines, similar to a roll of conventional paper towels.

In use, the oil permeated cooking wipe 10 can be easily removed from the dispenser 16 with one hand and quickly wiped across the cooking surface desired to be coated with little or no mess, after which the wipe can be discarded. It should be appreciated that the amount of cooking oil applied is easily controlled by the number or times the cooking surface is wiped and the amount of pressure applied to the wipe to cause the cooking oil to be released from the sheet. As such the present invention is useful for minimizing unwanted calories while still ensuring sufficient coating of the cooking surface to prevent food sticking.

The foregoing description is presented to enable one of ordinary skill in the art to make and use the invention and is provided in the context of a patent application and its requirements. Various modifications to the systems, methods and the general principles and features of the system and methods described herein will be readily apparent to those of skill in the art. Thus, the present invention is not to be limited to the embodiments of described above and illustrated in the drawing figures, but is to be accorded the widest scope consistent with the spirit and scope of the appended claims.

1. A cooking oil wipe for coating a cooking surface with cooking oil, comprising:
a sheet permeated with an amount of cooking oil to uniformly coat at least a typical household cooking surface, said sheet being sufficiently absorbent to retain said amount of cooking oil until said oil is transferred to the cooking surface by wiping.

2. The cooking oil wipe of claim 1 wherein said wipe is removably disposed in a dispenser.

3. The cooking oil wipe of claim 1 wherein said wipe is one of a plurality of like cooking oil wipes, each removably disposed in a dispenser.

4. The cooking oil wipe of claim 2 wherein said dispenser is a sealed envelope made of material impermeable to cooking oil.

5. The cooking oil wipe of claim 3 wherein said dispenser is a sealed envelope made of material impermeable to cooking oil and wherein said envelope includes a re-sealable opening.

6. The cooking oil wipe of claim 3 wherein said dispenser is a box made of material impermeable to cooking oil and wherein said box includes a re-sealable opening.

7. The cooking oil wipe of claim 5 wherein said plurality of like cooking oil wipes are disposed in stacked relation within said envelope.

8. The cooking oil wipe of claim 5 wherein said plurality of like cooking oil wipes are disposed in a roll within said envelope, each sheet removable from an adjacent sheet within said envelope along a tear line.

9. The cooking oil wipe of claim 6 wherein said plurality of like cooking oil wipes are disposed in stacked relation within said box.

10. The cooking oil wipe of claim 6 wherein said plurality of like cooking oil wipes are disposed in a roll within said box, each sheet removable from an adjacent sheet within said box along a tear line.

11. A system for coating a cooking surface with a cooking oil, comprising:
a dispenser; and
a sheet of material permeated with an amount of cooking oil, said sheet removable from said dispenser.

12. The system of claim 11 wherein said amount of cooking oil is sufficient to uniformly coat at least a typical household cooking surface and wherein said sheet is sufficiently absorbent to retain said amount of cooking oil until said cooking oil is transferred to the cooking surface by wiping.

13. The system of claim 12 wherein said oil permeated sheet is one of a plurality of like cooking oil permeated sheets, each removably disposed in said dispenser.

14. The system of claim 12 wherein said dispenser is a sealed envelope made of material impermeable to cooking oil.

15. The system of claim 13 wherein said dispenser is a sealed envelope made of material impermeable to cooking oil and wherein said envelope includes a re-sealable opening.

16. The system of claim 13 wherein said dispenser is a box made of material impermeable to cooking oil and wherein said box includes a re-sealable opening.

17. The system of claim 15 wherein said plurality of like cooking oil permeated sheets are disposed in stacked relation within said envelope.

18. The system of claim 15 wherein said plurality of like cooking oil permeated sheets are disposed in a roll within said envelope, each sheet removable from an adjacent sheet within said envelope along a tear line.

19. The system of claim 15 wherein said plurality of like cooking oil permeated sheets are disposed in stacked relation within said box.

20. The system of claim 15 wherein said plurality of like cooking oil permeated sheets are disposed in a roll within said box, each sheet removable from an adjacent sheet within said box along a tear line.
